(19) United States
(12) Patent Application Publication
(10) Pub. No.: US 2012/0120697 A1
(43) Pub. Date: May 17, 2012

(54) Three-phase isolated rectifer with power factor correction

(75) Inventor: Slobodan Cuk, Laguna Niguel, CA (US)

(73) Assignee: CUKS, LLC.

(21) Appl. No.: 12/927,391

(22) Filed: Nov. 13, 2010

(51) Int. Cl. H02M 7/06

(52) U.S. Cl. 363/126

(57) ABSTRACT

A new class of Three-Phase Isolated Rectifiers with Power Factor Correction provides a high efficiency, small size and low cost due to direct conversion from three-phase input voltage to output DC voltage.

### FIELD OF INVENTION

This invention relates to the field of AC-DC conversion with a Three-Phase input voltage, which can provide the galvanic isolation and Power Factor Correction performance features. The present solutions can provide these functions but to do so they use at least two cascaded power-processing stages: non-isolated three-phase PFC converter followed by an isolated DC-DC converter resulting in low efficiency, big size and weight and high cost.

The present invention opens up a new class of single-stage AC-DC converters with Three-Phase Input voltage, which provides both galvanic isolation and Power Factor Correction features by processing the three-phase AC input power to DC output power in a single power processing stage, thus resulting in much improved efficiency, reduced size and weight and lower cost. The new class of single-stage Three-Phase AC-DC converters was made possible by heretofore not available hybrid switching method for step-up conversion, which in turns results in a number of distinct switching converter topologies.

The prior art AC-DC converters using two stages are characterized by each power processing stage consisting of even number of switches, such as six for PFC converter and 8 for Isolated Dc-DC converter. The even number of switches is postulated by the present PWM square-wave switching technology, which explicitly forbids the existence of the converters with odd number of switches, such as 3, 5, etc. In a clear departure from the present classification, the new single-stage three-phase AC-DC converters introduced here all have a distinguishing characteristic of having a total of three switches I each phase and hence a total of nine switches, both odd number of switches.

### OBJECTIVES

The objective of this invention is to replace the existing two stage Three-Phase AC-DC converters with a Three-Phase AC-DC converter providing both galvanic isolation and Power Factor Correction features in a single power processing stage.

Three-phase input power has naturally high power factor, since even a direct six diode rectification of the three-phase line leads to very high power factor of over 96% due to the fact, that these diodes each conducts during their peak voltage and peak current conduction. Although, the Power factor in itself is not a problem with three-phase inputs, the harmonic content injected into the line is excessive and some form of active control (not a passive diode bridge) is required to reduce the harmonics in order to meet stringent requirements of IEC-1000-3-2 regulations.

### DEFINITIONS AND CLASSIFICATIONS

The following notation is consistently used throughout this text in order to facilitate easier delineation between various quantities:

1. DC—Shorthand notation historically referring to Direct Current but by now has acquired wider meaning and refers generically to circuits with DC quantities;

2. AC—Shorthand notation historically referring to Alternating Current but by now has acquired wider meaning and refers to all Alternating electrical quantities (current and voltage);

3. i₁, v₂—The instantaneous time domain quantities are marked with lower case letters, such as i₁ and v₂ for current and voltage;

4. I₁, V₂—The DC components of the instantaneous periodic time domain quantities are designated with corresponding capital letters, such as I₁ and V₂;
5. Δvᵣ—The AC ripple voltage on resonant capacitor Cᵣ;
6. f_{S}—Switching frequency of converter;
7. T_{S}—Switching period of converter inversely proportional to switching frequency f_{S};
8. T_{ON}—ON-time interval T_{ON}=DT_{S} during which switch S is turned ON;
9. T_{OFF}—OFF-time interval T_{OFF}=(1-D)T_{S} during which switch S is turned OFF;
10. D—Duty ratio of the main controlling switch S;
11. D′—Complementary duty ratio D′=1-D of the main controlling switch S;
12. fᵣ—Resonant frequency defined by resonant inductor Lᵣ and resonant capacitor Cᵣ;
13. Tᵣ—Resonant period defined as Tᵣ=1/fᵣ;
14. S—Controllable switch with two switch states: ON and OFF and defined to operate in first and third quadrants only;
15. CR₁—Two-terminal Current Rectifier whose ON and OFF states depend on S switch states and resonant period Tᵣ;
16. CR₂—Two-terminal Current Rectifier whose ON and OFF states depend on S switch states and resonant period Tᵣ;

### BRIEF DESCRIPTION OF THE DRAWINGS

FIG. 1a and FIG. 1b illustrate a prior art two stage-approach

FIG. 2a illustrates the present invention. FIG. 2b illustrates one of the isolated converters which can be used for each phase of the converter in FIG. 2a

FIG. 3a illustrates the PFC control via control of switch S. FIG. 2b illustrates line voltage and line currents of individual phases in converter of FIG. 2a. FIG. 3a compares the transformer fluxes.

FIG. 4a shows a separate PFC control of each phase and FIG. 4b the input current of each phase.

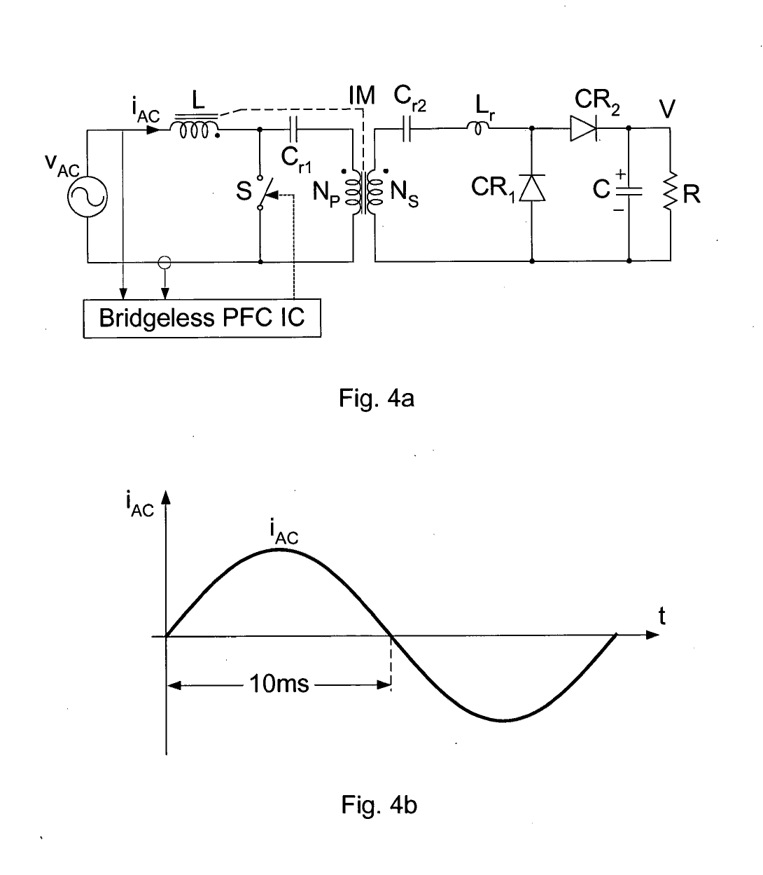

FIG. 5a illustrates the voltage of transformer and inductor, FIG. 5b illustrates the Integrated Magnetic structure and FIG. 5c shows zero ripple characteristic.

FIG. 6a shows the schematic of PFC control with standard PFC controller IC circuit and FIG. 6b shows how the resulting line current of each phase.

FIG. 7a shows a new Three-Phase Isolated Rectifier with PFC and corresponding Three-phase PFC Controller and FIG. 7b shows one specific phase converter.

FIG. 8a illustrates the line voltage and line currents of the converter in FIG. 7a and the instantaneous input power.

FIG. 9a shows the input three-phase currents and FIG. 9b shows the output phase currents.

FIG. 10a shows one input phase current and corresponding instantaneous input power and FIG. 10b shows all three instantaneous input powers and their sum.

FIG. 11a shows one output phase voltage and FIG. 11b shows how the ripple voltage on output is generated.

FIG. 12a shows a three-stage approach and FIG. 12b illustrates a single-stage approach.

FIG. 13a illustrates a practical implementation with Transorb, FIG. 13b shows the input switch voltage stress and FIG. 13c shows the voltage stress of the output switches. FIG. 13d is a circuit model for OFF-time interval.

FIG. 14a and FIG. 14b illustrate the lossless recovery of the spike energy.

FIG. 15a is and FIG. 15b are the definition of I-III quadrant operation of switch S.

FIG. 16a shows RGIGBT implementation of switch S and FIG. 16b and FIG. 16c respective quadrant definition.

FIG. 17a shows MOSFET implementation and FIG. 17b and FIG. 17c respective quadrant definitions.

FIG. 18a,b,c illustrates control methods.

FIG. 19a,b are the measurements of phase voltages and phase currents.

FIG. 20a,b are measurements of efficiency and power loss respectively

FIG. 21a is measurement of harmonies of the phase currents and FIG. 21b is start-up DC voltage characteristic.

### PRIOR-ART

Electrical power is transmitted efficiently over the long distance by use of the Three-Phase alternating transmission voltage operating at very high voltages of over 100,000 Volts and proportionally much reduced current to reduce the transmission losses. Then at the user end this high alternating (sinusoidal) voltage at 60 Hz transmission frequency is via three-phase 60 Hz transformers reduced to three-phase low alternating voltages of 400V per phase Thus, when the users need for power exceeds 2 kW to 3 kW, then invariably three-phase power is used as a main source for electrical equipment in industrial centers and in data centers where many computer servers are used to store and process the search and other computing information. Thus, the need for an AC-DC converters which can operate directly from the Three-Phase input power, generate isolated DC power at low DC voltages such as 48V and/or 12V for computers, but also operate with near unity Power factor to reduce the harmonics of the line frequency and reduce each one bellow regulated limits allowed for a given power.

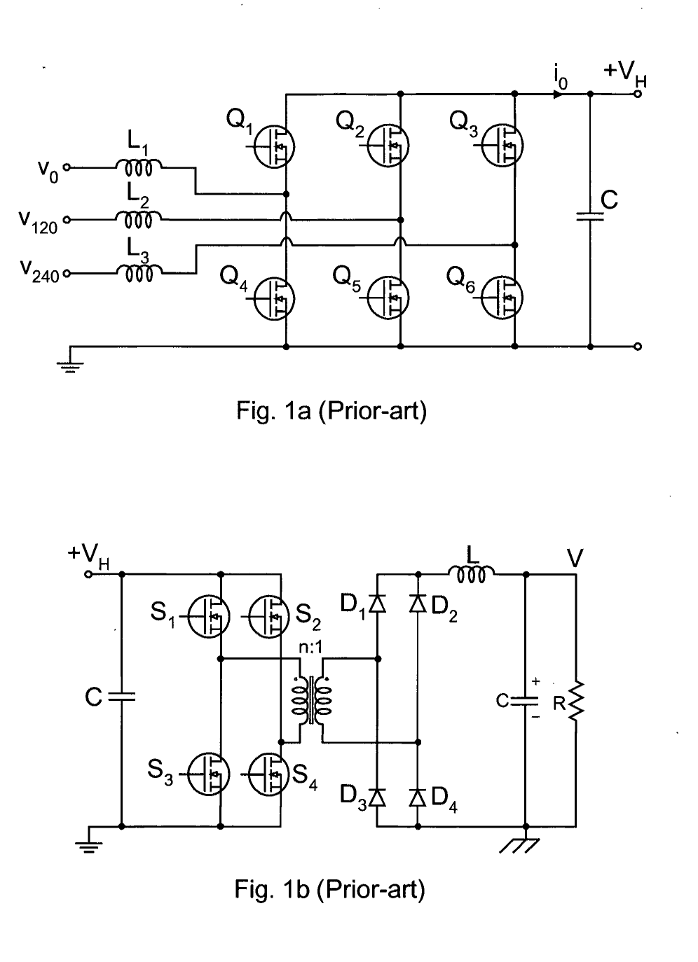

Until now no converter topology existed capable to do so in a single power processing stage. The most commonly used two-stage approach is illustrated n the prior art converter of FIG. 1a and FIG. 1b. First an active six transistors MOSFETs) boost type converter with three inductor is used to provide PFC conversion function and reduced line harmonics (FIG. 1a). Then the obtained 400V DC output voltage is used as an input source for the Full-bridge Isolated Converter having four primary active and controllable switches and four output rectifier diodes. Clearly such a two-stage approach is inefficient. For example if each processing stage is 95% efficient the overall efficiency is bellow 89%, which is about the current state of the art.

### BRIEF DESCRIPTION OF OPERATION

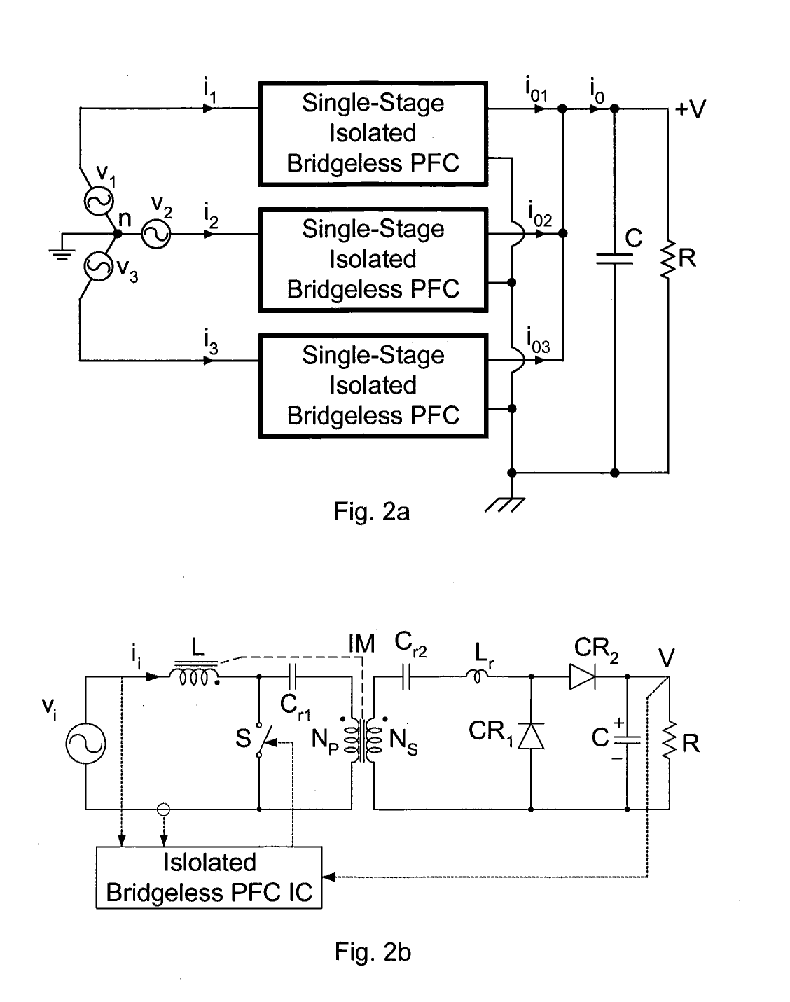

The present invention of a Three-phase AC-DC converters with isolation and Power Factor Correction provided in a single power processing stage is illustrated in general form illustrated in FIG. 2a with three identical AC-DC converters provided for each of the three phases of the four wire star connected three-phase inputs with neutral wire connected to input ground and each phase of the star connected four-wire three-phase high frequency galvanically isolated outputs are connected together and to the output DC terminal, while the secondary side neutral wire is connected to the DC output ground terminal.

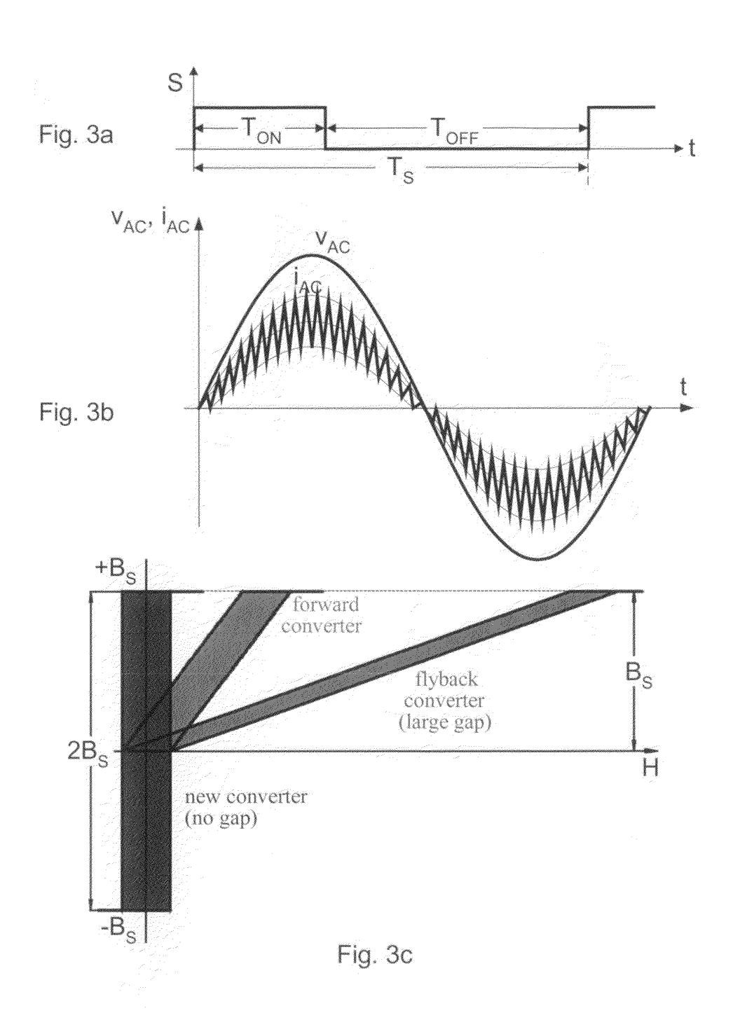

Block diagram in FIG. 2a, also shows that AC-DC converter in each phase is not just any converter, but that it must satisfy Isolated Bridgeless PFC criteria, such as a converter in FIG. 2b. The converter in FIG. 2b has a special converter topology:
a) it is capable of operating directly from one phase of the AC line voltage without a use of the usual full-bridge rectifier
b) it generates the same voltage step-up of 1/(1-D) for either positive or negative part of AC line to neutral voltage of each input [has.
c) Each phase has an Isolated bridgeless PFC controller, which forces via duty ratio D control of switch S as shown in FIG. 3a each phase current to be proportional to the respective phase voltage so that a unity input power factor is obtained for each phase as illustrated in FIG. 3b. Note how the input inductor current is chopped at very high switching frequency such as 100 kHz into a chopped current waveform but whose low frequency average is a sine way current at the low line frequency of 60 Hz which is in phase and proportional to the line voltage also at the same 60 Hz line frequency as seen in FIG. 3b.
d) Each phase has an isolation transformer, which is operating at the high switching frequency of 100 kHz and not the low 60 Hz line frequency thus dramatically reducing the overall rectifier size. As seen described in later section this transformer is not constrained by a 120 Hz current in its operation.
e) Three-phase input power has a fundamental property that the instantaneous power of the three-phases is constant in time, despite the sinusoidal input voltage and corresponding sinusoidal input current variation of each of the phases as was illustrated in FIG. 3b for one phase. Since output DC voltage and DC current have also constant power property, it follows that there is no DC storage in this Three-Phase rectifier to account for any difference in instantaneous input and output powers as is the case in a Single-Phase to DC conversion. Therefore, the isolation transformer is to the first order free from 120 Hz currents and need for the respective DC energy storage difference between output power and input instantaneous powers.

### Isolation Transformer Advantages

Isolation transformer of the converter in FIG. 2b is of the Cuk-type (used for the first time in the Cuk converter) and has the distinct advantages over the transformers used in the prior-art converters, such as flyback and forward converters as illustrated in FIG. 3c comparing the B-H loop characteristics of the three converters. Flyback converter store the DC energy and therefore must have an air-gap, which results in reduced magnetizing inductance and a large DC bias. Thus good portion of the available core flux must be allocated to the DC storage leaving remaining flux for AC flux excursions. Transformer in forward converter uses only positive portion of the core flux capability resulting in bigger core size needed. The transformer in present invention, on the other hand, uses full bi-directional flux capability of the core. In addition, this transformer does not store the DC energy and is built on the core with no air-gap resulting in large magnetizing inductance and small magnetizing current. Therefore this transformer can be scaled up for use in high power applications such as in three-phase input and still keep a high efficiency and small size of the transformer.

### Integrated Magnetics Embodiment

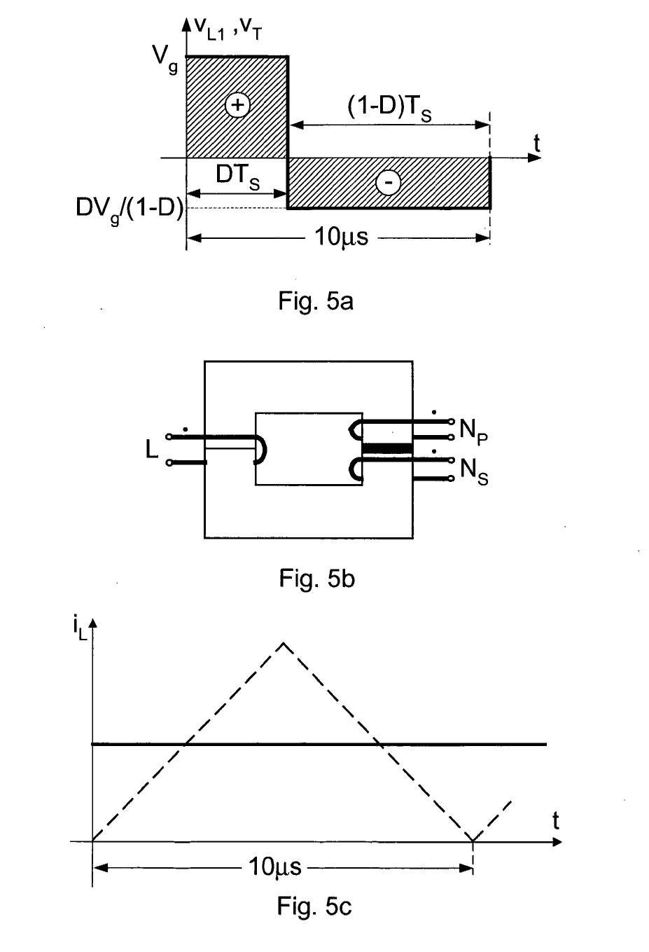

The voltage waveforms of the inductor L and transformer T in the converter of FIG. 2b are identical square-wave for any operating duty ratio D as seen on FIG. 5a. This then makes it possible to integrate the inductor and transformer on the common core to result in the integrated magnetics (IM) structure of FIG. 5b which in turn, by judicious design of the magnetics, will result in the removal of the input ripple current, or actually its shift into the transformer windings as seen in FIG. 5c in which the dotted line represents the high frequency inductor ripple current before magnetic coupling and full line represents a zero-ripple current of the input inductor after coupling. It should be noted that there is no need for adjustment of the air -gap nor winding turns in Integrated magnetics structure of FIG. 5b to achieve that result. This comes as a result of the placement proper placement of the air-gap as shown in FIG. 5b and the only constraint is that the input inductor and primary of the transformer must have the same number of turns.

### Single-Phase Isolated Bridgeless PFC Control

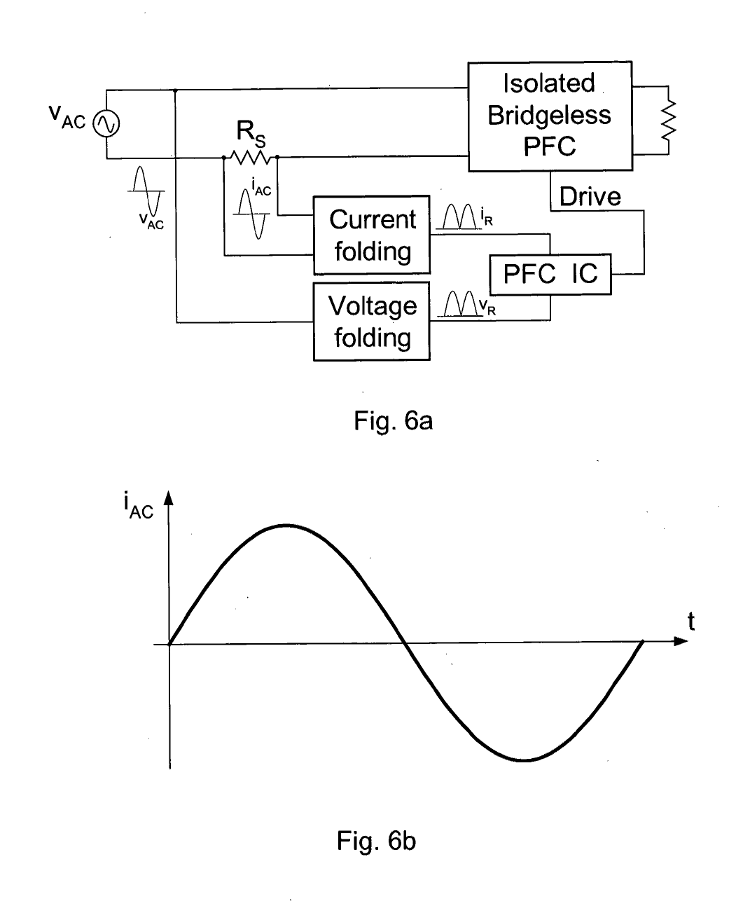

The single-stage Isolated PFC converter of FIG. 2a does not have a bridge rectifier so the control is as illustrated by the block diagram of FIG. 6a. The AC line voltage is sent directly to the bridgeless PFC converter to convert it to DC output.

In addition to a Bridgeless PFC Converter stage as shown in FIG. 6a corresponding new Isolated Bridgeless PFC controller IC is needed, which accepts as inputs the AC voltage directly and senses AC input current and controls the modulation of the high frequency switches in Isolated Bridgeless PFC Converter to force the input AC current to be proportional input AC voltage.

Such Bridgeless PFC Integrated Circuit Controllers do not exist currently. However, the existing PFC controller Integrated Circuits (IC's) operating from rectified AC line voltage and rectified AC line current could be used provided additional signal processing circuitry is implemented as shown in FIG. 6a. The additional circuitry recreates the rectified AC line voltage and rectified AC line current from the direct full wave AC line voltage and full-wave AC line current to result in AC line current of FIG. 6b.

Three-Phase Isolated Bridgeless PFC control

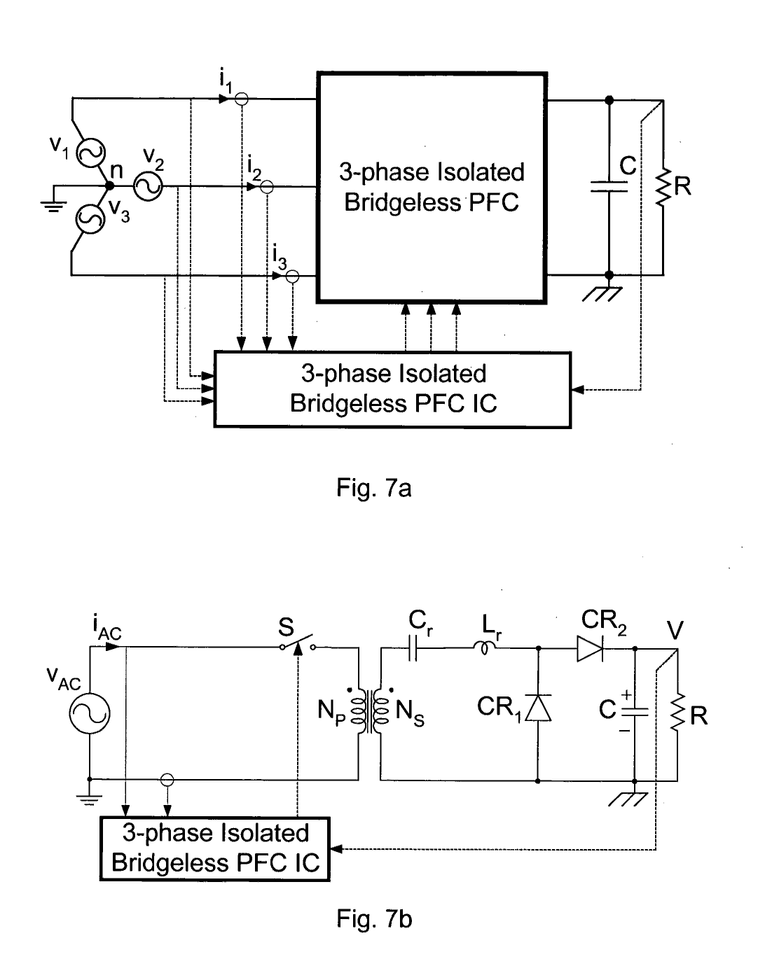

Although each phase can be operated independently and with its own separate isolated bridgeless PFC Controller, the controls for all three phases could be combined into a Three-Phase Isolated Bridgeless PFC controller as shown in FIG. 7a.

### Pulsating Input Current Embodiment

FIG. 7b shows yet another Isolated converter topology with pulsating input current, which satisfies the criteria needed to operate in a Three-Phase Isolated Bridgeless PFC converter structure of FIG. 7a.

### Detailed Description of Converter Operation

One of the key characteristics of the new Three-Phase Bridgeless PFC converters of FIG. 2a and FIG. 2b is that the switching converter in each phase is inherently capable of operating from either positive or negative AC input voltage. Thus we will explain separately first the operation of each phase converter from the positive input voltage and then from the negative input voltage to obtain the basic understanding of the operation of converter under two different input voltages, positive polarity and negative polarity input DC voltage for each phase. This will then be followed by the derivation of the conversion DC gain characteristics and resonant circuit analyses for each of the phase converters.

After operation of the converters in FIG. 2a in each phase is fully understood, the analysis of how these three phase converters operate in the Three-Phase configuration of FIG. 1a is made and unique performance characteristics derived analytically.

Finally, with operation under either positive or negative input voltages fully analytically characterized and understood, the operation from AC line voltage under Three=phase PFC control will be the easier to understand.

Here is a brief description of the converter operation, first for positive input voltage and then for negative input voltage.

Operation from Positive Input Voltage

First we analyze the operation of converter in FIG. 2a in which input voltage source is positive polarity DC voltage.

When switch S is turned-OFF, the DC current I of input inductor L forces the rectifier CR₂ to turn-ON and resonant capacitors Cᵣ₁ and Cᵣ₂ are charging while the load current was provided from the input voltage source. Subsequent turn-ON of switch S causes the rectifier CR₁ to turn-ON and capacitors Cᵣ₁ and Cᵣ₂ exchange their previously stored energy in a non-dissipative resonant fashion with the resonant inductor Lᵣ. If this resonant inductor were not present, the energy stored in resonant capacitors would during this interval be dissipated and lost in parasitic ESRs of the capacitors. This would clearly result in the reduced efficiency. Therefore, the resonant capacitors and resonant inductor even though not transferring the current to the load is not wasted, since the resonance is used to prepare the resonant capacitors for the next charging interval in next cycle.

For simplicity of the analytical derivations we assume that the isolation transformer in FIG. 2b is shorted so that a non-isolated version is obtained in which the series connection of two resonant capacitors is replaced by a single equivalent resonant capacitor Cr and the DC voltage V_{Cr} on it. All results thus derived will be also applicable to the original isolated versions, which will only use the turns ratio scaling into the results obtained below.

The Volt-second (flux balance) on inductor L in FIG. 2b requires that

V_{g}DT_{S}=(V+V_{Cr}−V_{g}) (1−D)T_{S} (1)

Unlike the PWM inductor L, which is flux balanced over the entire period T_{S}, the resonant inductor Lᵣ must be fully flux balanced during the ON-time interval only, resulting in:

V_{Cr}=0 (2)

as the resonant inductor cannot support any net DC voltage since the integral of the AC ripple voltage Δvᵣ over the ON-time interval must be by definition zero. Therefore, the DC voltage V_{Cr} of the resonant capacitor Cᵣ must be zero so that the volt-second balance is satisfied on the resonant inductor Lᵣ.

Using the result (2) in (1), the DC conversion ratio is obtained as:

V/V_{g}=1/(1−D) (3)

Note that the same DC conversion ratio as in the prior-art boost converter is obtained. Furthermore, despite the resonant circuit consisting of resonant capacitor Cᵣ and resonant inductor Lᵣ, the DC conversion does not depend on either one of them and their values or the switching period T_{S}, but only depends on the operating duty ratio D. Thus despite this hybrid switching described in later section, the simple DC conversion ratio as in square-wave switching converters is obtained. Hence, the regular duty ratio control can be employed to use this converter as a basis for PFC control as in prior-art boost converter. However, unlike prior-art boost converter, this converter will accept both positive and negative polarity input voltage. However, to achieve that function, we need to prove that the same DC conversion ratio as in (3) will also be obtained for operation with negative polarity input voltage source.

We now postpone the detailed analysis of the resonant circuit and development of analytical results for later section on Resonant Circuit Analysis.

Operation from Negative Input Voltage

Next we analyze the operation of the converter in FIG. 2b in which input voltage source is negative polarity. The Volt-second (flux) on inductor L requires that for the steady-state they must be balanced so that:

V_{g}DT_{S}=(V_{Cr}−V_{g})(1−D)T_{S} (4)

The resonant inductor Lᵣ must be once again fully flux-balanced during the same ON-time interval DT_{S} only so that this time:

V_{Cr}=V (5)

as the resonant inductor cannot support any net DC during this ON-time interval.

Note that the steady state DC voltage on the resonant capacitor has changed from (2) to (5), that is from V_{Cr}=0 to V_{Cr}=V.

Replacing now (5) into (4) we get the DC conversion ratio for the negative polarity input voltage as:

V/V_{g}=1/(1−D) (6)

which is the same as (3) for positive input polarity voltage.

Therefore, despite different DC voltages on the resonant capacitor for positive input voltage (zero) and for negative input voltage (output DC voltage), the DC conversion gain functions are equal.

The DC voltage gain of the converter when the isolation transformer turns ratio is included is then given by

V/V_{g}=N_{S}/N_{P}(1−D) (7)

### Resonant Circuit Analysis

Operation of the converter in FIG. 2a from positive input voltage and negative input voltage, results in the resonant circuit models, which can be both described by the same first order differential equations introduced below for the same ON-time interval. Here we once again assume a simplified non-isolated version of the converter in FIG. 2b

For simplicity, and without loss of generality, we assumed that the input inductor current I_{L} is large so that the superimposed ripple current is negligible and can be considered constant at the DC level I_{L}. The resonant solution is obtained as:

iᵣ(t)=I_{P} sin(ωᵣt) (8)

v_{Cr}(t)=Δvᵣ cos(ωᵣt) (9)

Δvᵣ=I_{P}R_{N} (10)

R_{N}=√Lᵣ/Cᵣ (11)

Where R_{N} is the natural resistance and

ωᵣ=1/√LᵣCᵣ (12)

fᵣ=ωᵣ/(2π) (13)

where fᵣ is the resonant frequency and ωᵣ radial frequency.

The initial voltage Δvᵣ at the beginning of resonant interval can be calculated from input inductor current I_{L} during (1-D)T_{S} interval as:

Δvᵣ=½I_{L}(1−D)/(Cᵣf_{S}) (14)

Substitution of (10) and (11) into (14) results in

I_{P}=I_{L}(1−D)πfᵣ/f_{S} (15)

### Hybrid Switching Method

The above relationship of equal DC conversion gains as a function of duty ratio for both positive and negative polarity input voltages, makes it possible to use the same converter topology with an AC input voltage directly and with the bridge rectifier being eliminated.

The new hybrid switching method is now emerging. The ON-time switching interval for either polarity of the input voltage will result in resonant switching network for ON-time interval, and regular PWM network for OFF-time interval, thus justifying the name proposed of hybrid switching consisting partly of square-wave switching (applicable to PWM inductor L for both switching intervals) and to resonant switching applicable to resonant inductor during only the ON-time interval. Hence hybrid switching is a combination of the square-wave (PWM) switching and resonant switching having the PWM inductor and resonant inductor.

The isolated converter in FIG. 2a employs the Hybrid Switching method. It consists of three switches: one active controlling switch S whose ON-time modulation is illustrated in FIG. 3a and two passive diode rectifier switches CR₁ and CR₂, which are turning ON and OFF in response to the state of the main switch S for either positive or negative polarity of the input AC voltage. As the input voltage polarity changes, the minimal implementation of the switch S is that it must be voltage bi-directional, that is it should be able to block either voltage polarity of the input AC voltage and conduct current correspondingly when it is turned-ON (current bi-directional!). If no single semiconductor switch can perform such function a composite switch can be made out of existing active switching devices, as illustrated later.

Note that the odd number of switches, three (3), is already a distinctive characteristic of this converter with respect to all conventional switching converters, which always come with an even number of switches, such as 2, 4, 6 etc. In conventional PWM converters this was dictated by the requirement of square-wave switching using both inductive and capacitive energy transfers (often called PWM switching), which requires that the switches come in complementary pairs: when one switch is ON its complementary switch is OFF and vice versa. This, in turn, is consequence of the fact that when inductances store energy capacitances are releasing stored energy and vice versa.

Here no such complementary switches exist, as one active switch S alone is controlling both diode switches, not only for positive polarity of input voltage AC line voltage but also for negative polarity of input voltage.

Note that this is accomplished with the fixed topological connection of the two current rectifiers, which automatically change their ON-time intervals and OFF-time intervals as needed by the polarity of the input AC voltage. For example, for the positive polarity of the AC input voltage, current rectifier CR₁ conducts during the ON-time interval of switch S. Then for negative polarity of AC input voltage, the same current rectifier conducts during the OFF-time interval of controlling switch S. The current rectifier CR₂ also responds automatically to the polarity of the input AC voltage. For the positive polarity it is conducting during OFF-time interval of switch S and for negative polarity it is conducting during the ON-time interval of switch S.

Described from the switch S controlling point of view:
a) for positive polarity of input AC voltage, turning ON of switch S forces current rectifier CR₁ to turn-ON and simultaneously forces current rectifier CR₂ to turn OFF
b) for negative polarity of input AC voltage, turning ON of switch S forces current rectifier CR₂ to turn-ON and simultaneously forces current rectifier CR₂ to turn OFF.

Thus the three switches are operating at all times, for both positive and negative cycles of the input AC line voltage. Hence in present invention the component utilization is 100%. The efficiency is especially for the low line of 85V AC since the two diode drops of full bridge rectifier are eliminated.

Resonant Capacitor and Inductor Size

The converter in FIG. 2a has also an energy transferring capacitor, which during the OFF-time interval T_{OFF} charges and at the same time passes the input charging current to the load. Then during the ON-time interval T_{ON} this capacitor forms a resonant circuit with the resonant inductor Lᵣ and exchanges the energy stored in previous OFF-time interval with resonant inductor. This resonant inductor is much smaller than PWM inductor L, since its C flux is one to two orders of magnitudes smaller than the AC flux of PWM inductor L resulting in a very small magnetic core needed for its implementation. As a result, it stores a much less inductive energy than the PWM inductor.

### Analysis of the Operation of the Three-Phase Rectifier

We now describe and analyze the unique operation of the Three-Phase Isolated Rectifier of FIG. 7a, when the three converters of FIG. 2b are used in each of its three phases. A

The equality of the DC conversion gains as a function of duty ratio D of the controlling switch S for either polarity of the input phase voltage is a very important pre-requisite for a converter to operate as a Single-Stage Three-Phase Isolated Bridgeless AC-DC converter. Another important factor is that both DC conversion gains are having a step-up DC gain characteristic which is another pre-requisite needed for the converter topology to qualify as boost type PFC converter. This therefore establishes that the present invention is indeed capable to operate as Single-Stage Three-Phase Isolated Bridgeless PFC converter.

### PFC Control

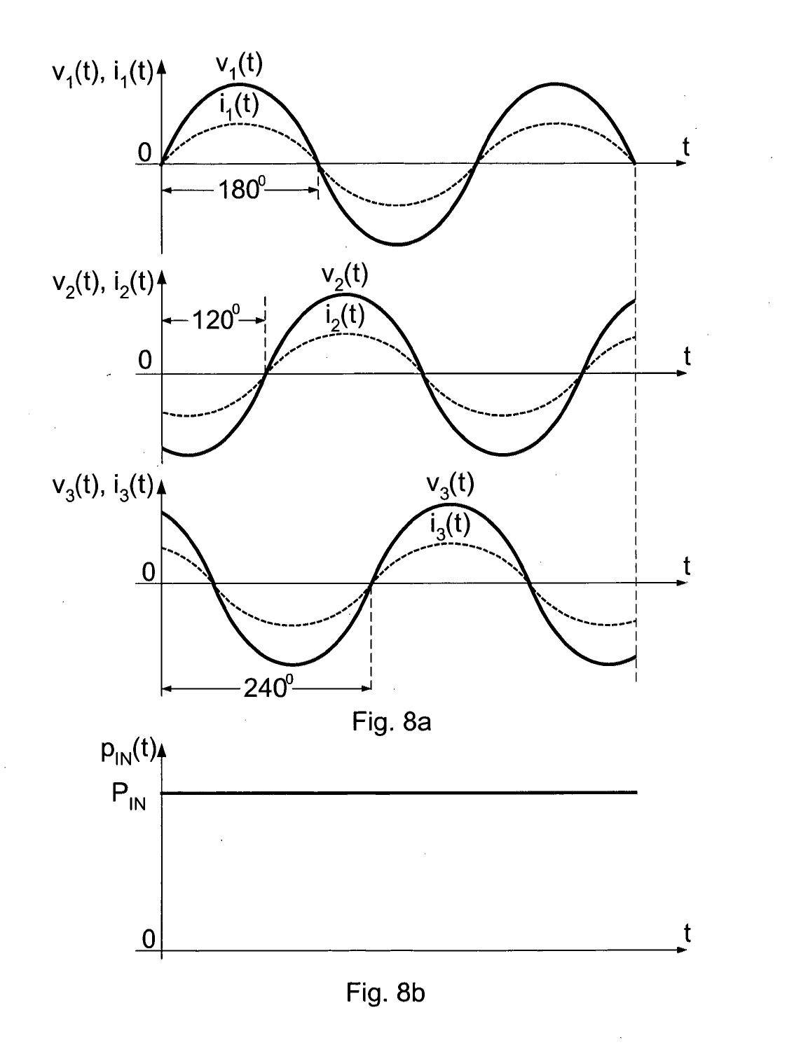

The Power Factor Correction is based on controlling the average input current of the phase to neutral converters of the Three-Phase converter in FIG. 7a to become in phase and proportional to the input AC line voltage by use of the PFC IC controller so that the voltage and current waveforms as in FIG. 8a are obtained and Unity Power factor performance achieved. The three phase voltages can then be described analytically:

v₁=V₁ sin ω t (16)

v₂=V₂ sin(ω t−120) (17)

v₃=V₃ sin (ω t−240) (18)

ω=2π f (19)

where f is the utility line frequency such as 60 Hz in United States and 50 Hz I Europe.

Under the unity power factor control, the corresponding phase to neutral input current of each phase are then described analytically as:

iₜ=I₁ sin ω t (16)

i₂=I₂ sin(ω t−120) (17)

i₃=I₃ sin (ω t−240) (18)

One extraordinary property of the above balanced three-phase system is that the instantaneous power of such a system is constant in time as shown in FIG. 8b despite the fact that each individual phase has clearly a large time varying and pulsating power. This is expressed analytically as:

v₁i₁+v₂i₂+v₃i₃=0 (19)

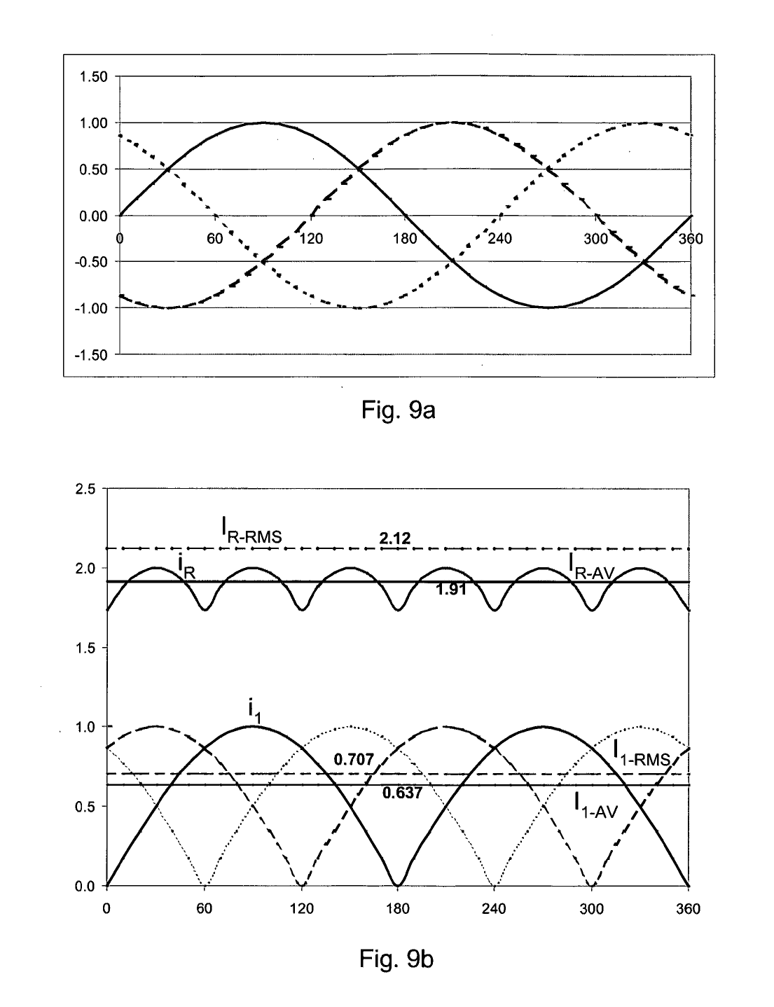

Another property of the three-phase current under a unity power factor operation and a balanced load conditions (equal load in each phase) is that the sum of all three input phase currents are equal to zero, so that the current in the neutral wire is also zero despite the large fluctuations of individual phase currents as seen in the waveforms of FIG. 9a. Thus:

i₁+i₂+i₃=0 (20)

However, each current delivered to the output by each individual phase converter is a rectified version of the respective sinusoidal input phase current so that the total output current consists of the summation of the three rectified sine wave phase shifted in time by 120 degrees, so that the contribution of each phase to the load current is depicted with the three rectified current waveforms in FIG. 9b which results in a total current to the DC load designated as I_{R-AV} in FIG. 9b which has a small 8% peak to peak variation relative to this average DC value. Note that the above represents only the actual total load current, which will be observed. The actual total rms current delivered to the load I_{R-RMS} is on the other hand given by:

I_{R-RMS}=3 I_{1-RMS} (21)

where I_{1-RMS} is rms current delivered by one of the output phases. If the magnitude of individual phase currents on input are normalized and have peak value equal to 1, that is I₁=1, then total rms load current is 2.12 and individual phase rms currents are 0.707=√2/2. Note also that the load current is almost constant with only 4% (or 25 time) smaller half-peak ripplre current relative to average current. In addition the ripple current is at frequency 6 times higher them the fundamental 60 Hz line frequency or at 360 Hz effectively. Thus, this 360 Hz ripple current can be considered to have a minimal effect o the output DC load.

Note also that one should not confuse the actual phase current discussed above with the average phase currents which in the above example are 0.637 in magnitude, where 0.637=2/π and the total average load current is then 1.91.

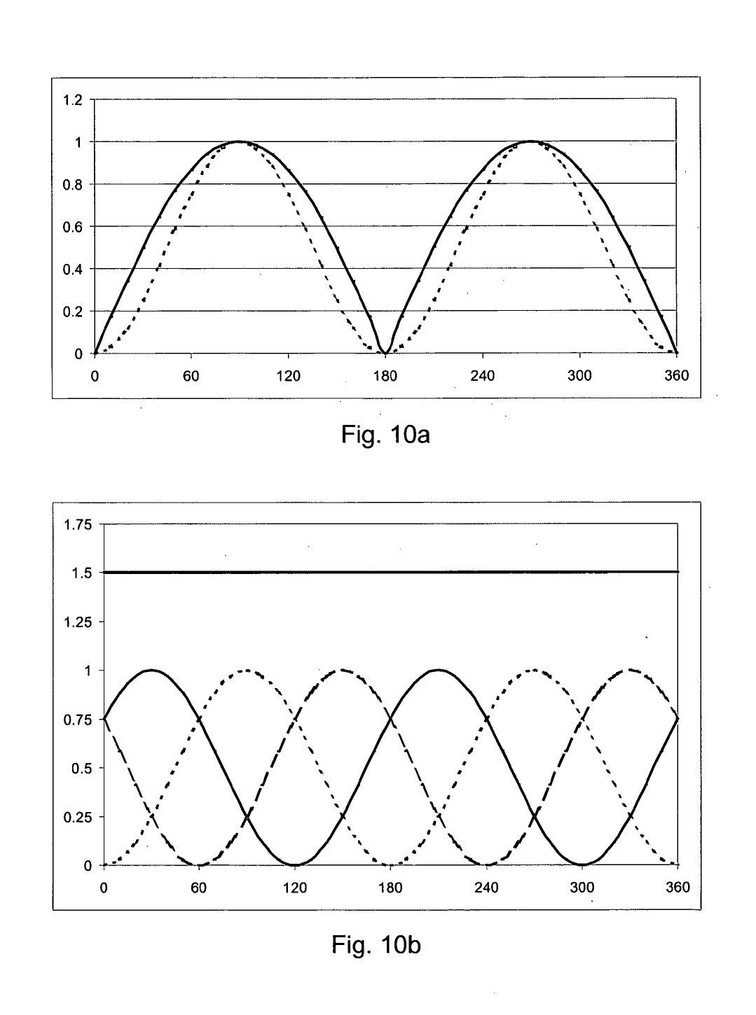

Each individual phase converter does not store any energy and therefore delivers the pulsating power to the load, but this time, the current is not full-wave sinusoid, but instead a rectified sinusoidal current as shown in FIG. 10a in heavy lines. The corresponding instantaneous power deliver to the load by that phase is again the same pulsating power as described previously for the input current assuming here 1:1 turns ratio of the respective high switching frequency (100 kHz) transformer. Thus, the output phase currents would only be scaled-in magnitude by respective high frequency transformers turns ratio but will not change the shape shown in FIG. 10a by the dotted lines.

When all three instantaneous output powers are represented on the same diagram, the three pulsating powers are again shown at twice the line frequency and add together to the constant output power as also shown in FIG. 10b as a straight line at the level of 1.5, since each phase has an average power of 0.5 for this particular case.

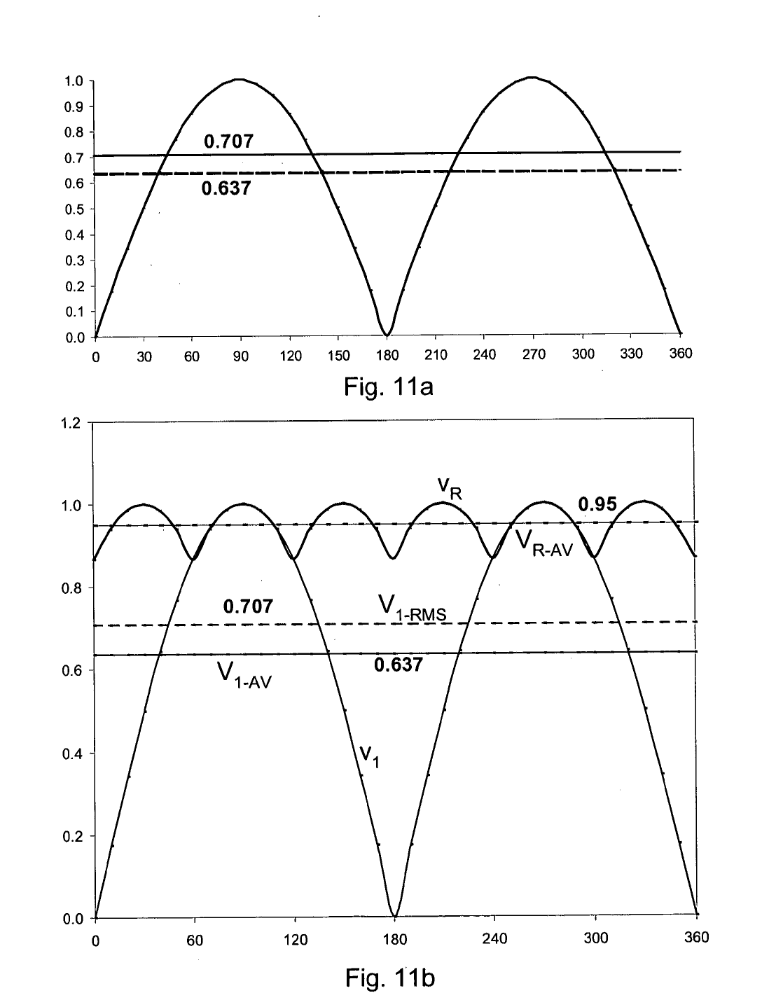

We now turn to the analysis of the output instantaneous voltage and its ripple voltage. Shown in FIG. 11a is the output voltage of a single phase, which is also a rectified version of the full-wave sinusoidal input voltage. The respective definition of rms voltage and average voltage are also illustrated in FIG. 11a. Since each phase converter performs the role of the voltage rectification of respective input phase voltage, the resulting output voltage is therefore obtained as in FIG. 11b to consist of the 360 Hz ripple voltage. Individual rectified voltage of one phase is shown in FIG. 11b to conduct only during the peaks of corresponding output phase voltages, much in the same wave as the 6 diode rectifier would do when used to rectify the three phase input voltages in a classical 6 diode three-phase rectification scheme.

### Comparison of Three-Stage and Single-Stage Processing

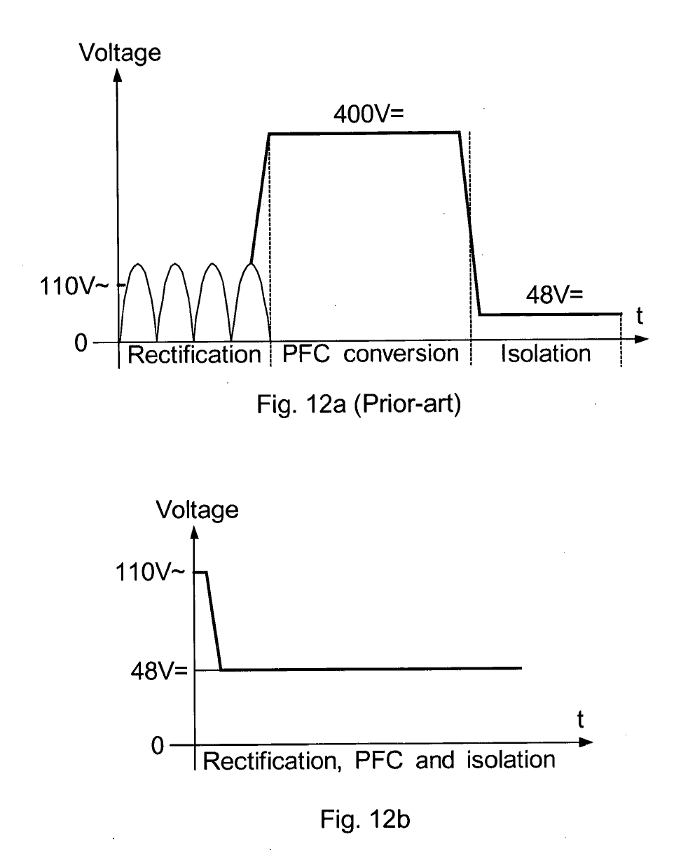

The conventional Single Phase power conversion is processing the input power in three stages and sequentially as illustrated in FIG. 12a: first through full-bridge rectification, then through PFC conversion stage and finally through an Isolated DC-DC conversion stage and in the process steps-up the voltage to intermediate high DC voltage bus used for DC energy storage.

In the present invention of Three-Phase Isolated PFC converter, the power is processed in a single-stage, so that the rectification, PFC conversion and isolation are performed in a single power processing stage and without the need to go to high voltage intermediate DC us voltage. Furthermore, the input power is divided processed in parallel through three individual phase converters. Thus for example a total 6 kW power is processed as 2 kW power per each phase. In the prior art converter of FIG. 1a and FIG. 1b, the power is processed in two sequential cascaded stages with the second Isolated DC-DC converter processing the full power of 6 kW. Clearly both requirements lead to much reduced overall efficiency which is currently limited to around 90%. The present invention on the other hand using the same components as conventional scheme has a demonstrated capability to increase efficiency to 98%.

### Voltage Stresses of the Switches

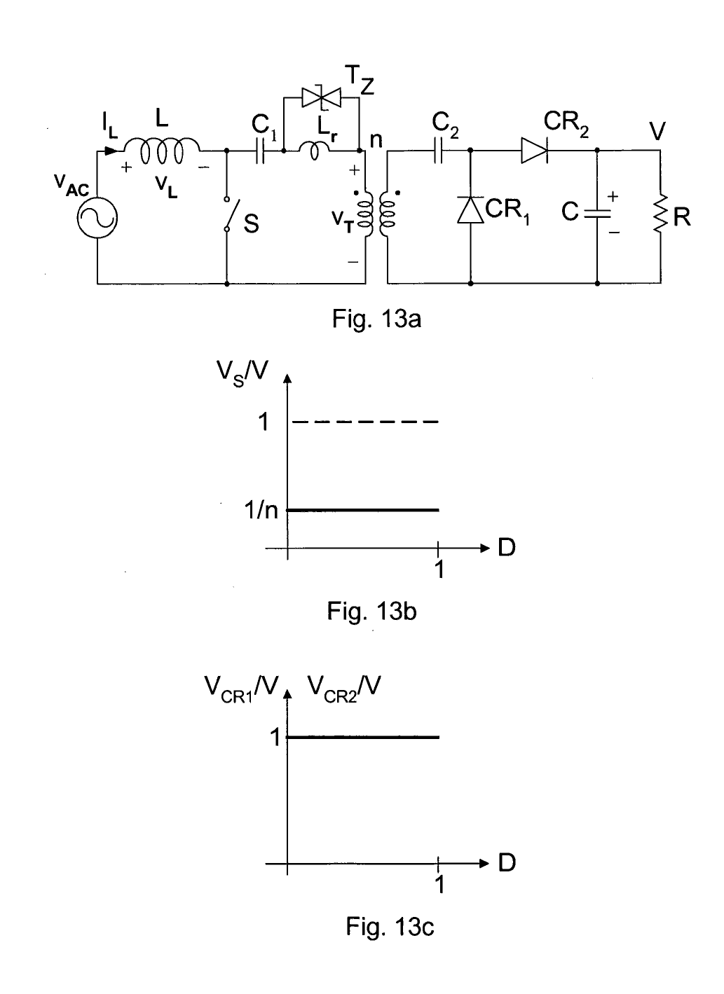

The low voltage stresses of the switches in the isolated extension of converter of FIG. 13aa are shown graphically in FIG. 13b for primary switch S and in FIG. 13c for secondary side rectifiers. The secondary side rectifiers have the voltage stresses equal to the output DC voltage and therefore result in minimum possible voltage stress and maximum utilization of the output switches.

Transorb Implementation

The current direction in resonant inductor is changing form one direction in OFF-time interval to another direction in ON-time interval. This change of the direction of inductor current during the short transition would cause the voltage spike on the switch S. The faster the change, the bigger the voltage spike would be. However, due to small energy stored in this small inductor, this spike can be effectively suppressed by use of a Zener diode, which would limit the voltage spike but dissipate the energy in Zener diode. Since the converter operates for both polarities of the input voltage, the bi-directional Zener diode, called Transorber is used as shown in later section. This, once again would dissipate all of the spike energy and limit the spike voltage such as in the converter of FIG. 13a.

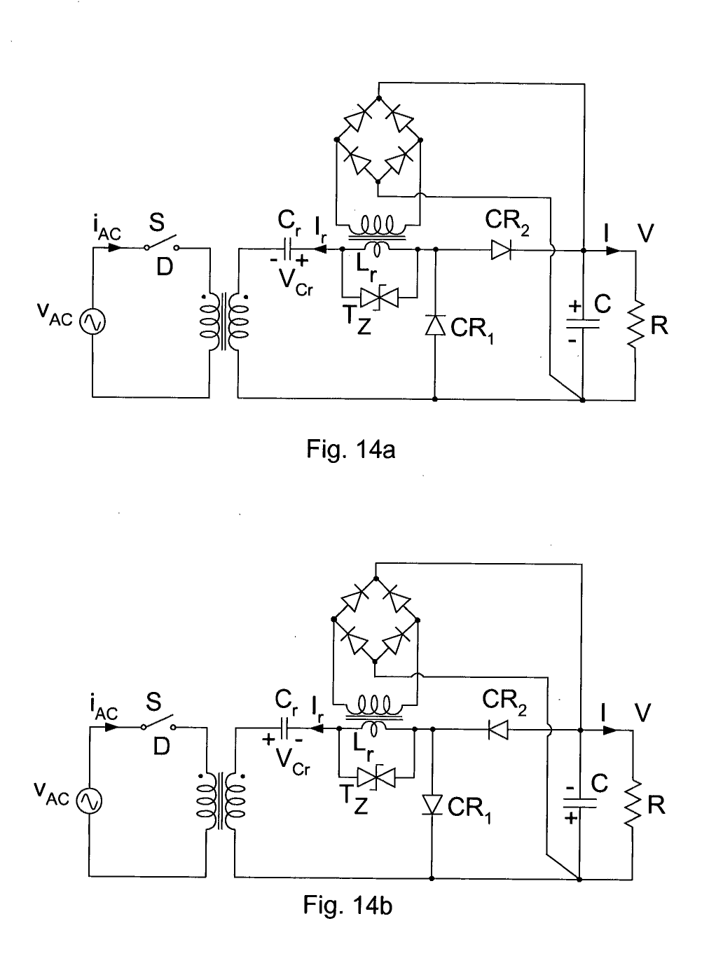

The dissipative loss can be much reduced by use of the energy recovery switching circuit, such as for example one illustrated for the pulsating input current converters of FIG. 14a and FIG. 14b. The resonant inductor has an additional secondary winding which through a full-bridge diode rectifier connected to the secondary winding is releasing that energy to the load. Clearly, since the energy in this transitional change is very small, both the secondary winding and diode-bridge are rated only to the small recovery energy they are processing. Thus a low power, small full-bridge diode rectifier packaged in a small chip could be used to minimize space used for this energy recovery network. To simplify further presentations, the converter schematics will omit these energy recovery-switching circuits and show various converter extensions using only a transorber T_{Z}. However, this and other energy-recovering network that one skilled in the art might devise, could be used in all of them in order to increase the efficiency.

The current rectifiers, however, change their roles automatically, depending whether the input voltage is positive or negative as described above. In conclusion, the unique converter topology in conjunction with the single resonant inductor Lᵣ results in implementation of three switches (one active two-quadrant switch and two passive, single quadrant current rectifier switches) is one of several reasons that a single-stage Bridgeless AC-DC converter is made possible. The second reason is that a single input inductor L generates in conjunction with the above switching action, the needed step-up conversion function for either polarity of input voltage. The third reason is the presence of the resonant inductor Lᵣ placed in series with the resonant capacitor Cᵣ, resulting in hybrid switching operation described above, which is the method enabling the same step-up voltage gain for either of the two input voltage polarities as detailed analysis enclosed reveals.

### Implementation of Switch S

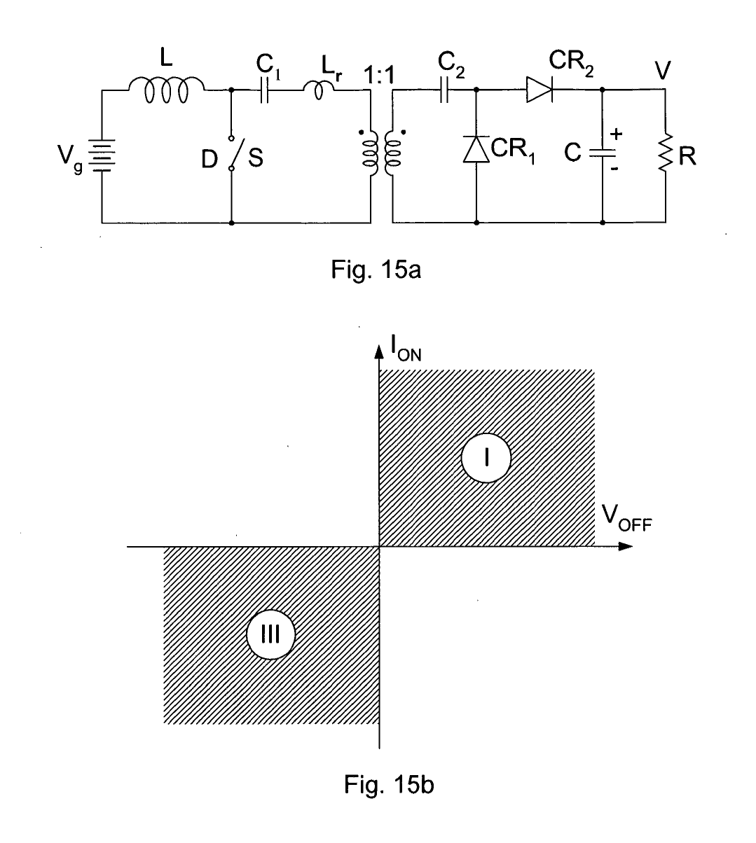

In addition to two simple diode rectifiers the present invention, the phase converter of FIG. 15a has one component, the controlling switch S whose implementation is critical to the overall efficiency.

From the description of the converter operation for positive and negative output voltages, it is clear that this switch S has two-quadrant switching characteristic operating in the first and third quadrant as illustrated in definition of switch S in FIG. 5a. In other words, the switch S must block voltage of one polarity and conduct current in one direction, but also it should be able to block the voltage of opposite polarity and conduct the current in opposite direction.

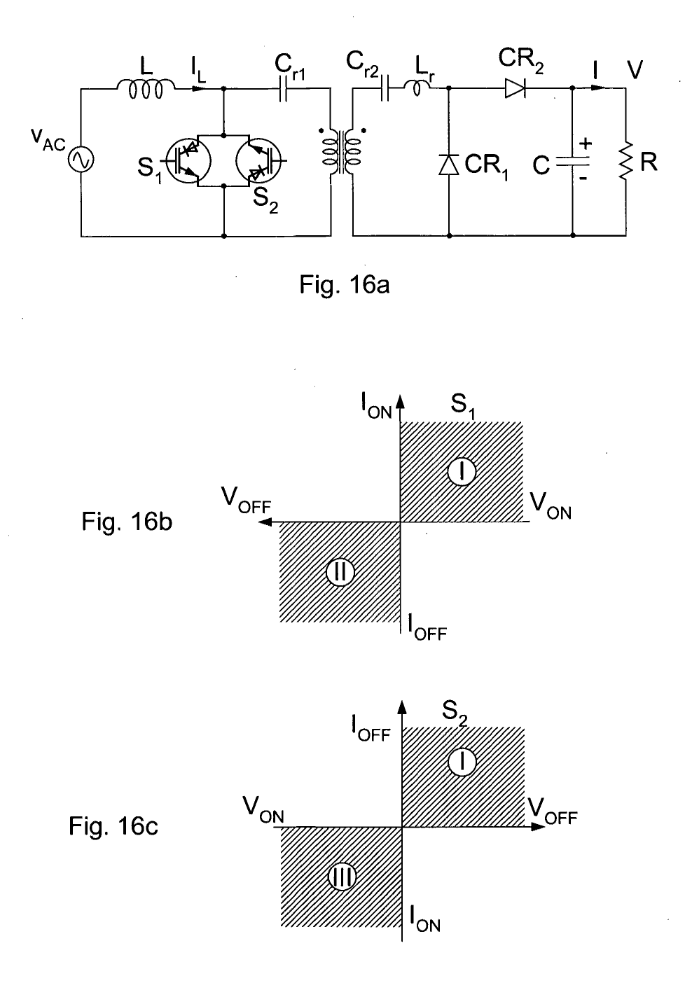

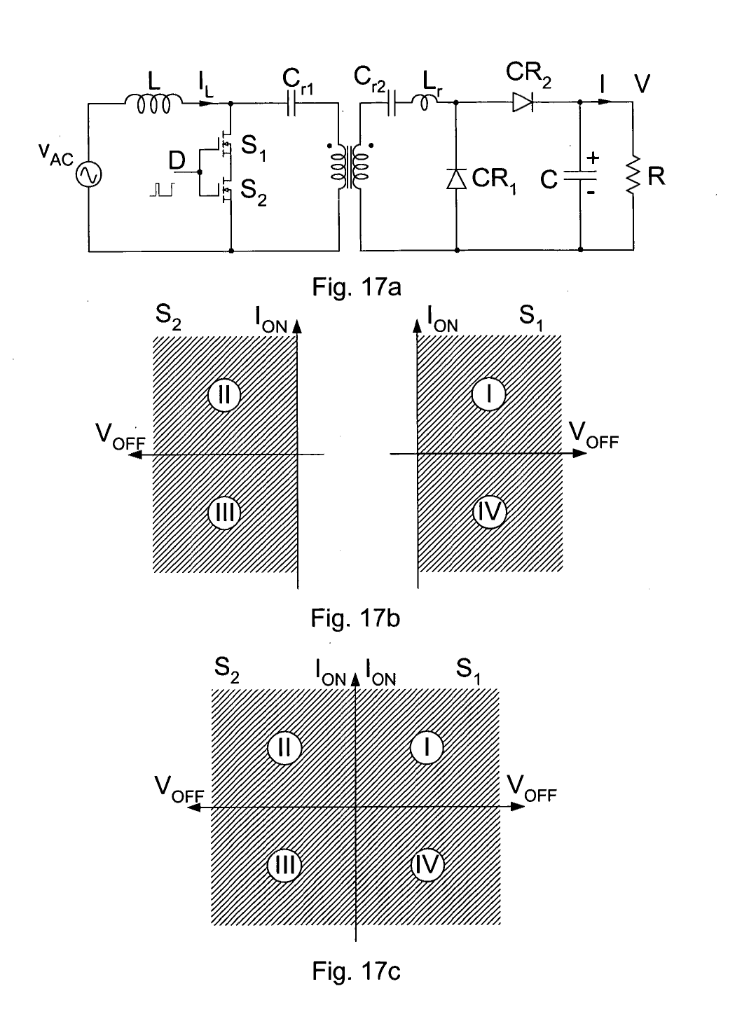

One implementation is to use two Reverse Blocking Isolated Gate Bipolar Transistor (RBIGBT) devices in parallel such as illustrated in FIG. 16a. Each of these devices is able to operate as a switch in one quadrant but also capable of blocking a full opposite voltage as illustrated by its individual quadrant characteristic of FIG. 16b. Therefore, two such switches operated in parallel would once again form an effective first-third quadrant switch of FIG. 16c. Unfortunately, at present such a switching characteristic is not available in a single semiconductor-switching device, so that its performance must be simulated by use of the two devices connected in cascade as shown by use of two n-channel MOSFET devices S1 and S₂ connected back to back as in FIG. 17a and using a common floating drive circuitry. Shown in FIG. 17b and FIG. 17c are the respective two quadrant characteristics of each current bi- directional MOSFET switch. Therefore, their combination produces in effect a four-quadrant switch with characteristic as in FIG. 17c whereas the two-quadrant characteristic of FIG. 16c would be sufficient except such a single device does not exist at present time. It is expected that in the future a single two-quadrant switch having characteristic of FIG. 16c will be produced. This could reduced the conduction losses of the switch S by up to a factor of four, since two n-channel devices could be connected in parallel and not in series. Alternatively, for the same losses, the switch costs could be reduced significantly.

### PFC Control Options

The duty ratio modulation is used to control average input current of individual phase converters. The control of input current is then accomplished in two possible ways described below. The ON-time interval starts at zero level, which effectively constricts the resonant discharge interval to exactly one-half of the resonant period, that is

D_{R}T_{S}=Tᵣ/2 (22)

Tᵣ=1/fᵣ (23)

We have also introduced here a notion of the resonant duty ratio D_{R}. The resonant circuit is therefore formed by the loop consisting of two resonant components, Cᵣ and Lᵣ, switch S and respective current rectifiers connected in series as shown earlier hence limiting discharge current to only one direction. The discharge current starts at zero and ceases to conduct after half resonant interval when resonant current becomes zero again.

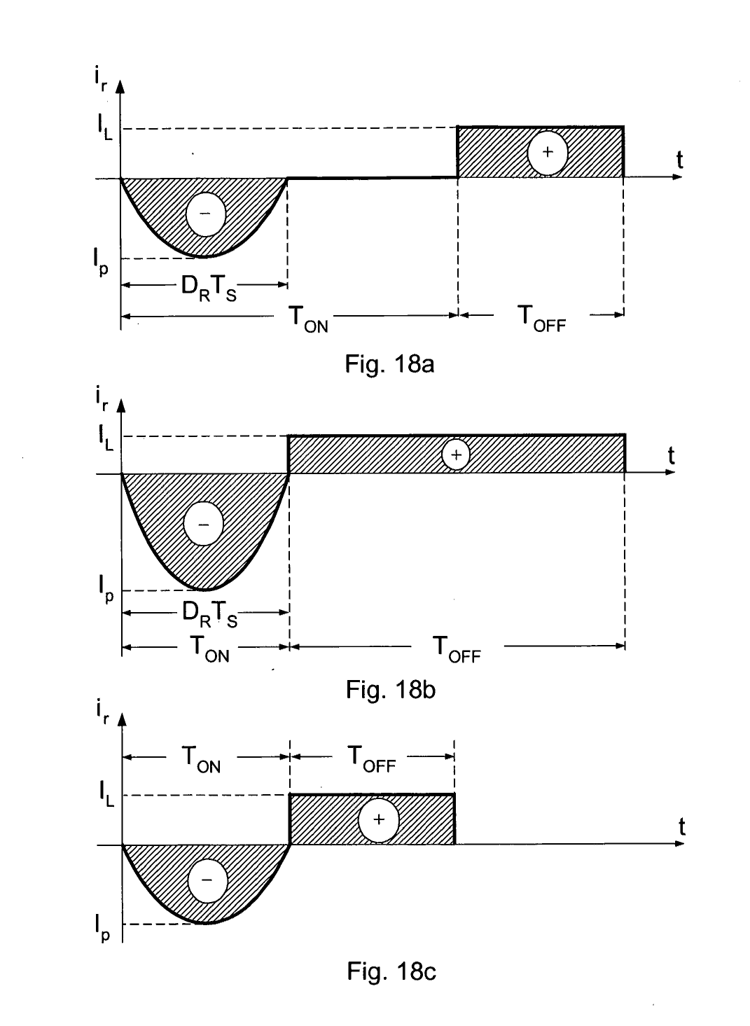

There are now two possible modes of operation to control the average input current:
1. Duty ratio modulation with constant switching frequency such as illustrated by the diagrams in FIG. 18a band FIG. 18b .
2. Constant ON-time and variable OFF time and therefore, variable switching frequency as illustrated in FIG. 18b and FIG. 18c

For highest efficiency and best operational mode, zero coasting intervals present in constant switching frequency operation should be eliminated. This is easily accomplished as follows. If the ON-time of the switch S is equal to half of a resonant period, then the resonant discharge current waveform will be exactly half a sine wave. The best mode of operation is then to keep the ON-time constant as per:

T_{ON}=DTₛ=Tᵣ/2=constant (24)

so that duty ratio is proportional to switching frequency, or:

D=f_{S}/2fᵣ (25)

where ωᵣ and fᵣ are as defined earlier.

Thus, voltage regulation is obtained by use of the variable switching frequency f_{S}. However, this results in corresponding duty ratio D as per (25). Note that all DC quantities, such as DC voltages on capacitors and DC currents of inductors are still represented as a function of duty ratio D only, as in the case of constant-switching frequency operation.

The waveforms of FIG. 18a,b,c show the constant ON-time (interval DTₛ) displayed first to emphasize the variable OFF-time and variable switching frequency as well as the elimination of zero coasting intervals of constant switching frequency operation.

### Experimental Verifications

The Three-Phase isolated PFC converter on an experimental 900 W prototype, which converts Three-Phase input voltage into a 400V isolated output voltage (1:1 isolation transformer used) with very high efficiency over the wide range.

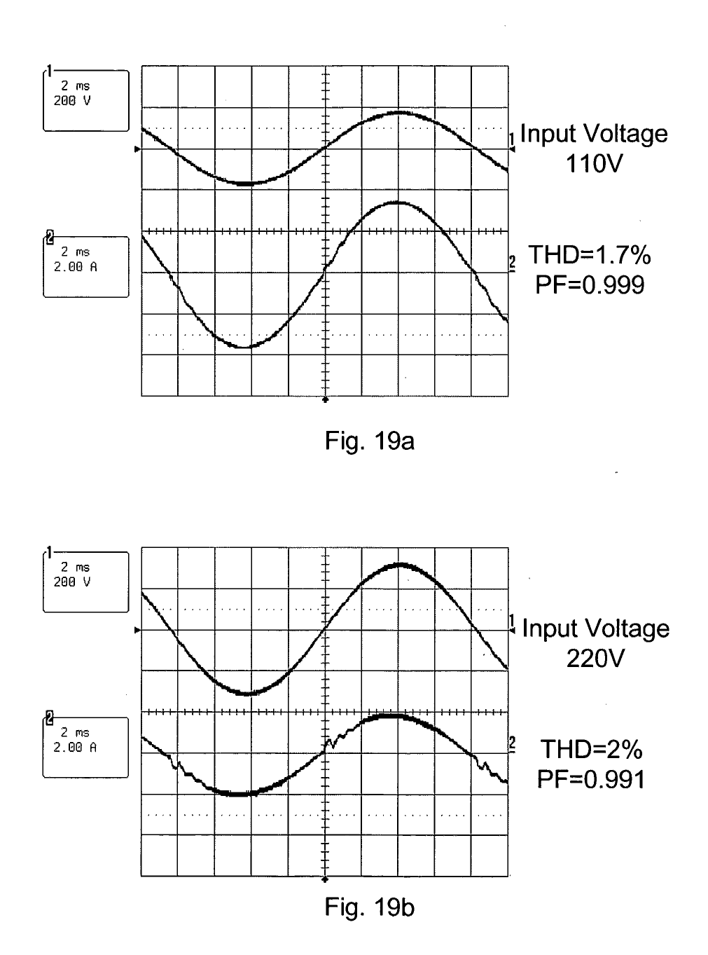

FIG. 19a shows the line voltage (top trace) and AC line current (bottom trace) of one phase of 60 Hz input voltage for 110V input voltage. The Power factor was measured at 900 W load to be 0.999 and THD 1.7%.

FIG. 19b shows the line voltage (top trace) and AC line current (bottom trace) of one phase at 220V AC and 60 Hz. The Power factor was measured at 900 W load to be 0.991 and THD 2%.

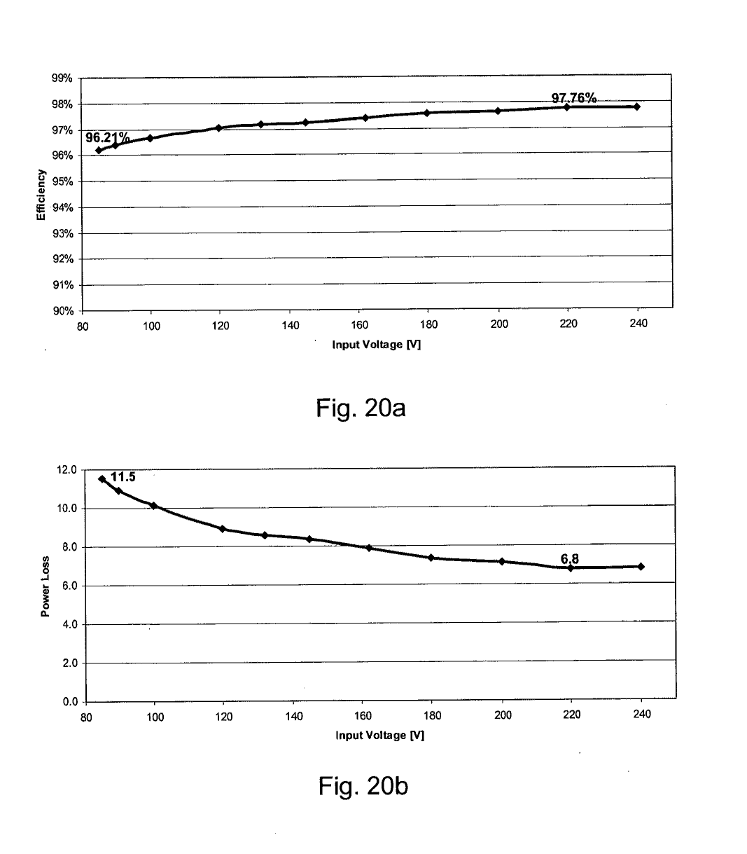

FIG. 20a shows the efficiency measurements at a 900 W level over the wide input AC voltage range from 85V AC to 240V AC and FIG. 42b shows the corresponding FIG. 43a shows the line voltage (top trace) and AC line current (bottom trace). The Power factor was measured at 900 W load to be 0.999.

Very high efficiency of over 97% is measured over the wide input AC voltage. In particular note the very high efficiency at the low AC line voltage of 85V AC as shown in FIG. 20a while the low total losses are shown in FIG. 20b. This clearly indicates the absence of the bridge rectifier on the front and single-stage power processing.

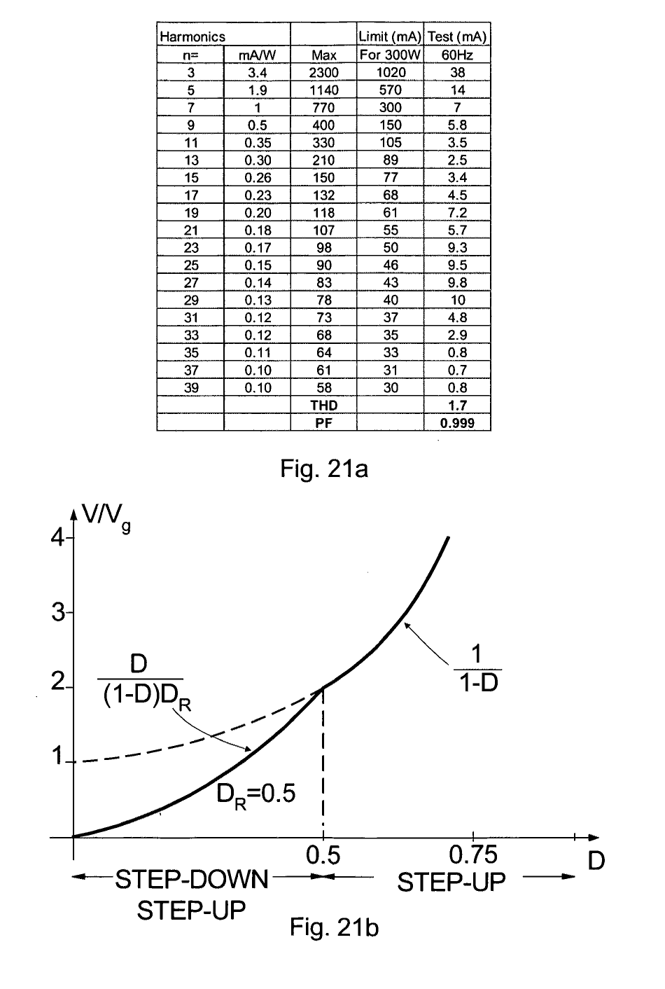

The measurement of harmonics currents is displayed in the Table shown in FIG. 21a

### Converter Start-up

The DC gain characteristic of (3) suggests that the isolated converter would have the start-up problem as the DC gain characteristic is always greater than 1. Yet at start-up the output DC voltage is zero (discharged output capacitor) which would tend to indicate that the converter would never be able to start-up as it does not have the Dc conversion gain extending to zero at low duty ratios. However, this is not correct as this converter does have a special mode of operation at low duty ratios.

Shown in FIG. 21b with thin dotted lines is the ideal DC conversion gain characteristic given by (3). The actual measured DC conversion characteristic shown in heavy lines, reveals the existence of the region at very low duty ratios during which the DC conversion gain drops to zero. Therefore, effectively, the actual DC conversion gain is that of a step-down/step-up type. Thus, the output DC voltage even in the isolated converter case can be started smoothly from zero DC output voltage and brought by duty ratio increase into a step-up DC conversion region for the operation as an isolated Three-Phase PFC controller.

### CONCLUSION

The Single-Stage Three-Phase Isolated Rectifier PFC is provided which provides the direct conversion form three-phase input to DC isolated output. Therefore, the present invention results in several basic advantages:
1. Higher efficiency
2. Reduction of the cost
3. Reduction of the size
4. Full utilization of all the components for both positive and negative part of the input AC cycle as there are no idle components in either cycle.
5. Single magnetics, low cost implementation.
6. Low voltage stresses on all switches.
7. DC voltage step-up function.

What is claimed is:

1. An isolating three-phase switching converter having a three-phase AC input voltage with a first phase connected between a first input terminal and a common input terminal, a second phase connected between a second input terminal and said common input terminal and a third phase connected between a third input terminal and said common input terminal, providing power to a DC load connected between three output terminals connected together (a first output terminal, a second output terminal and a third output terminal) and a common output terminal, said isolating three-phase switching converter comprising three identical single-phase isolating switching AC/DC converters with Power Factor Correction feature, each said single-phase isolating switching AC/DC converter having an single-phase AC input voltage connected to respective phase of said three-phase AC input voltage between respective said input terminal and said common input terminal and providing power to a DC load connected between respective said output terminal and said common output terminal, a first single-stage isolated switching converter of said three identical single-phase isolating switching AC/DC converters comprising:
an input inductor winding and a primary and a secondary winding of an isolation transformer placed on a common magnetic core to form an Integrated Magnetics, each winding having a dot-marked end and an unmarked end, said input inductor winding connected at said unmarked end thereof to said first input terminal, said primary winding of said isolation transformer connected at said unmarked end thereof to said common input terminal, and said secondary winding of said isolation transformer connected at said unmarked end thereof to said common output terminal;
an input switch with one end connected to said common input terminal and another end connected to said dot-marked end of said input inductor;
a first resonant capacitor with one end connected to said dot-marked end of said primary winding of said isolation transformer and another end connected to said dot-marked end of said input inductor;
a second resonant capacitor with one end connected to said dot-marked end of said secondary winding of said isolation transformer;
a resonant inductor winding connected at one end thereof to another end of said second resonant capacitor;
a first diode switch with an anode end connected to said common output terminal and a cathode end connected to another end of said resonant inductor winding;
a second diode switch with an anode end connected to said cathode end of said first diode switch and a cathode end of said second diode switch connected to said first output terminal;
switching means for keeping said input switch ON for a duration of time interval DT_{S} and keeping it OFF for a complementary duty ratio interval (1-D)T_{S}, wherein D is a duty ratio of said input switch and T_{S} is a switching period;
wherein said input switch is a controllable semiconductor voltage bi-directional switching device, capable of conducting the current in either direction while in an ON-state, and sustaining voltage of either polarity, while in an OFF-state;
wherein said first diode switch and said second diode switch are semiconductor current rectifier switching devices controlled by both said ON-state and said OFF-state of said input switch and polarity of said single-phase AC input voltage;
wherein said first diode switch and said second diode switch either conduct or block the current depending on both said states of said input switch and polarity of said single-phase AC input voltage so that a DC voltage is provided to said DC load.
wherein depending on both said states of said input switch and polarity of said single-phase AC input voltage said resonant inductor and said second resonant capacitor form resonant circuits either with said first diode switch or with said second diode switch, each conducting a half sine-wave resonant current during one half of a resonant period;
wherein leakage inductance between said input inductor winding and said primary and secondary windings of said isolation transformer provides substantially zero-ripple current in said input inductor winding;
wherein said switching means use both a voltage signal and a current signal from said single-phase AC input voltage to control said ON-state and said OFF-state of said input switch in a such a way to force a current from said single-phase AC input voltage to be proportional and in phase with said single-phase AC input voltage;
wherein turns ratio of said secondary winding to said primary winding of said isolation transformer provides additional control of voltage conversion ratio of said single-phase switching converter, and
wherein said isolation transformer provides galvanic isolation between said single-phase AC input voltage and said DC load.

2. A converter as defined in claim 1,
wherein said first single-stage isolated switching converter of said three identical single-phase isolating switching AC/DC converters comprising:
an isolation transformer with a primary winding and a secondary winding, each said winding having a dot-marked end and an unmarked end;
said primary winding of said isolation transformer connected at said unmarked end thereof to said common input terminal;
said secondary winding of said isolation transformer connected at said unmarked end thereof to said common output terminal;
an input switch with one end connected to said first input terminal and another end connected to said dot-marked end of said primary winding of said isolation transformer;
a resonant capacitor with one end connected to said dot-marked end of said secondary winding of said isolation transformer;
a resonant inductor winding connected at one end thereof to another end of said capacitor;
a first diode switch with an anode end connected to said common output terminal and a cathode end connected to another end of said resonant inductor winding;
a second diode switch with an anode end connected to said cathode end of said first diode switch and a cathode end of said second diode switch connected to said first output terminal;
switching means for keeping said input switch ON for a duration of time interval DTₛ and keeping it OFF for a complementary duty ratio interval (1-D)T_{S}, wherein D is a duty ratio of said input switch and T_{S} is a switching period;
wherein said input switch is a controllable semiconductor voltage bi-directional switching device, capable of conducting the current in either direction while in an ON-state, and sustaining voltage of either polarity, while in an OFF-state;
wherein said first diode switch and said second diode switch are semiconductor current rectifier switching devices controlled by both said ON-state and said OFF-state of said input switch and polarity of said single-phase AC input voltage;
wherein said first diode switch and said second diode switch either conduct or block the current depending on both said states of said input switch and polarity of said single-phase AC input voltage so that a DC voltage is provided to said DC load.
wherein depending on both said states of said input switch and polarity of said single-phase AC input voltage said resonant inductor and said resonant capacitor form resonant circuits either with said first diode switch or with said second diode switch, each conducting a half sine-wave resonant current during one half of a resonant period;
wherein said switching means use both a voltage signal and a current signal from said single-phase AC input voltage source to control said ON-state and said OFF-state of said input switch in a such a way to force a current from said single-phase AC input voltage source to be proportional and in phase with said single-phase AC input voltage;
wherein turns ratio of said secondary winding to said primary winding of said isolation transformer provides additional control of voltage conversion ratio of said converter, and
wherein said isolation transformer provides galvanic isolation between said single-phase AC input voltage and said DC load.

3. A converter as defined in claim 1,
wherein said first and said second output semiconductor current rectifier switches are replaced by MOSFET switching transistors devices operated as synchronous rectifiers in order to reduce the conduction losses and increase the efficiency of said converter.

4. A converter as defined in claim 1,
wherein said voltage bi-directional input switch is implemented by use of the two re-channel MOSFET switching transistors connected in series and back-to-back so that their source terminals are connected together and their gate terminals are connected together, while their drain terminals provide the end terminals of this composite switch operating in first and third quadrant.
